(19) United States
(12) Patent Application Publication
(10) Pub. No.: US 2023/0252423 A1
(43) Pub. Date: Aug. 10, 2023

(54) PUBLIC LEDGER OF PROFESSIONALS WHO HAVE ACCESS HOME VIA AN ACCESS CONTROL TO ASSIST BUYERS

(71) Applicant: CARRIER CORPORATION, Palm Beach Gardens, FL (US)

(72) Inventors: Ramesh Lingala, Hyderabad (IN); Teri Lynne Briskey, Monmouth, OR (US); Subhash Reddy Gopavaram, Hyderabad (IN); Mahesh Kodamati, Hyderabad (IN); Aswin Sukumaran Nair, Hyderabad (IN); Adam Cooper, Independence, OR (US)

(21) Appl. No.: 18/163,065

(22) Filed: Feb. 1, 2023

Related U.S. Application Data
(60) Provisional application No. 63/306,753, filed on Feb. 4, 2022.

(51) Int. Cl. G06Q 10/1093; G06Q 50/16

(52) U.S. Cl. CPC G06Q 10/1093; G06Q 50/16

(57) ABSTRACT

A method of documenting services performed for a secured property including: receiving a first actuation request from a service person via a service person computing device, the first actuation request being directed to an access control of the secured property; detecting a first actuation of the access control in response to the first actuation request; receiving service details, the service details describing a service being performed at the secured property associated with the first actuation request; saving the service details in a public ledger; receiving a second actuation request from a potential buyer via a potential buyer computing device, the second actuation request being directed to the access control; detecting a second actuation of the access control in response to the second actuation request; and granting authorization to the potential buyer to view the public ledger via the potential buyer computing device in response to the second actuation.

### CROSS-REFERENCE TO RELATED APPLICATIONS

This application claims the benefit of U.S. Provisional Application No. 63/306,753 filed Feb. 4, 2022, all of which are incorporated herein by reference in their entirety.

### BACKGROUND

The embodiments herein generally relate to access control devices, and, more specifically, a method and apparatus to monitor access to access control devices.

Real-estate property buyers typically have to rely exclusively on disclosure forms provided by the seller to understand the history of the property. These disclosure forms are often incomplete or inaccurate, which may lead to a potential buyer making a decision based on incomplete data or providing feedback on the property based on incomplete data.

### BRIEF DESCRIPTION

According to one embodiment, a method of documenting services performed for a secured property is provided. The method including: receiving a first actuation request from a service person via a service person computing device, the first actuation request being directed to an access control of the secured property; detecting a first actuation of the access control in response to the first actuation request; receiving service details, the service details describing a service being performed at the secured property associated with the first actuation request; saving the service details in a public ledger; receiving a second actuation request from a potential buyer via a potential buyer computing device, the second actuation request being directed to the access control of the secured property; detecting a second actuation of the access control in response to the second actuation request; and granting authorization to the potential buyer to view the public ledger via the potential buyer computing device in response to the second actuation.

In addition to one or more of the features described above, or as an alternative, further embodiments of may include that receiving the service details further includes: receiving the service details from the service person via the service person computing device.

In addition to one or more of the features described above, or as an alternative, further embodiments of may include that receiving the service details further includes: receiving the service details from a host of the secured property via a host computing device.

In addition to one or more of the features described above, or as an alternative, further embodiments of may include that saving the service details in the public ledger further includes: saving the service details in the public ledger located on one or more property service cloud databases.

In addition to one or more of the features described above, or as an alternative, further embodiments of may include that saving the service details in the public ledger further includes: saving the service details in the public ledger located on a blockchain.

In addition to one or more of the features described above, or as an alternative, further embodiments of may include that the service details are a description of what service is being performed at the secured property that necessitated the service person to access the secured property through the first actuation of the access control.

According to another embodiment, a property service tracking system for documenting services performed for a secured property is provided. The property service tracking system including: an access control configured to control access to the secured property; a property service cloud database in communication with the access control, the property service cloud database including: a processor; and a memory including computer-executable instructions that, when executed by the processor, cause the processor to perform operations, the operations including: receiving a first actuation request from a service person via a service person computing device, the first actuation request being directed to the access control of the secured property; detecting a first actuation of the access control in response to the first actuation request; receiving service details, the service details describing a service being performed at the secured property associated with the first actuation request; saving the service details in a public ledger; receiving a second actuation request from a potential buyer via a potential buyer computing device, the second actuation request being directed to the access control of the secured property; detecting a second actuation of the access control in response to the second actuation request; and granting authorization to the potential buyer to view the public ledger via the potential buyer computing device in response to the second actuation.

In addition to one or more of the features described above, or as an alternative, further embodiments of may include that receiving the service details further includes: receiving the service details from the service person via the service person computing device.

In addition to one or more of the features described above, or as an alternative, further embodiments of may include that receiving the service details further includes: receiving the service details from a host of the secured property via a host computing device.

In addition to one or more of the features described above, or as an alternative, further embodiments of may include that saving the service details in the public ledger further includes: saving the service details in the public ledger located on one or more property service cloud databases.

In addition to one or more of the features described above, or as an alternative, further embodiments of may include that saving the service details in the public ledger further includes: saving the service details in the public ledger located on a blockchain.

In addition to one or more of the features described above, or as an alternative, further embodiments of may include that the service details are a description of what service is being performed at the secured property that necessitated the service person to access the secured property through the first actuation of the access control.

According to another embodiment, a method of documenting services performed for a secured property is provided. The method including: receiving a first actuation request from a service person via a service person computing device, the first actuation request being directed to an access control of the secured property; detecting a first actuation of the access control in response to the first actuation request; receiving service details, the service details describing a service being performed at the secured property associated with the first actuation request; saving the service details in a public ledger; receiving a public ledger request from a potential buyer via a potential buyer computing device; and granting authorization to the potential buyer to view the public ledger via the potential buyer computing device in response to the public ledger request.

In addition to one or more of the features described above, or as an alternative, further embodiments of may include that receiving the service details further includes: receiving the service details from the service person via the service person computing device.

In addition to one or more of the features described above, or as an alternative, further embodiments of may include that receiving the service details further includes: receiving the service details from a host of the secured property via a host computing device.

In addition to one or more of the features described above, or as an alternative, further embodiments of may include that saving the service details in the public ledger further includes: saving the service details in the public ledger located on one or more property service cloud databases.

In addition to one or more of the features described above, or as an alternative, further embodiments of may include that saving the service details in the public ledger further includes: saving the service details in the public ledger located on a blockchain.

In addition to one or more of the features described above, or as an alternative, further embodiments of may include that the service details are a description of what service is being performed at the secured property that necessitated the service person to access the secured property through the first actuation of the access control.

Technical effects of embodiments of the present disclosure include tracking visits by service persons to the property in a public ledger, documenting what service was performed at each visit in the public ledger, and then providing the public ledger to potential buyers of the property when the property is listed for sale.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 is a schematic diagram of an exemplary property service tracking system, according to an embodiment of the present disclosure;

FIG. 2 is a flow process illustrating an exemplary method of documenting services performed for a secured property is illustrated, according to an embodiment of the present disclosure; and

FIG. 3 is a flow process illustrating an exemplary method of documenting services performed for a secured property is illustrated, according to an embodiment of the present disclosure.

### DETAILED DESCRIPTION

A detailed description of one or more embodiments of the disclosed apparatus and method are presented herein by way of exemplification and not limitation with reference to the Figures.

As aforementioned, real-estate property buyers typically have to rely exclusively on disclosure forms provided by the seller to understand the history of the property. These disclosure forms are often incomplete or inaccurate, which may lead to a potential buyer making a decision based on incomplete data. The embodiments disclosed herein seek to provide a method and apparatus of tracking visits by service persons to the property in a public ledger, documenting what service was performed at each visit in the public ledger, and then providing the public ledger to potential buyers of the property when the property is listed for sale.

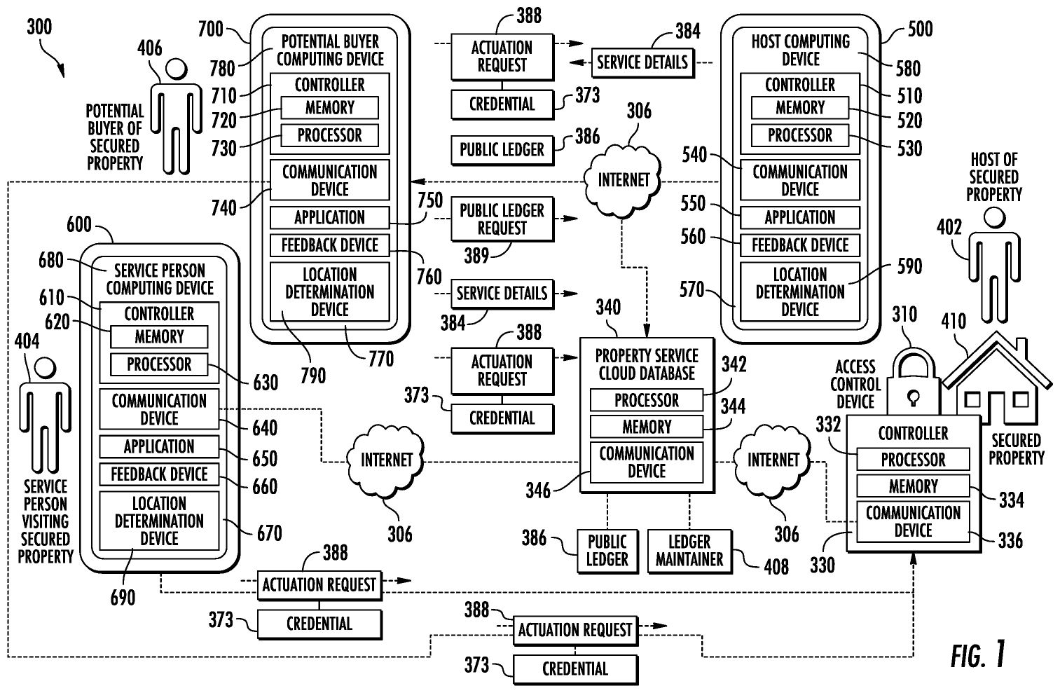

Referring now to FIG. 1, a schematic diagram of an exemplary property service tracking system 300 is illustrated, according to an embodiment of the present disclosure. It should be appreciated that, although particular systems are separately defined in the schematic block diagrams, each or any of the systems may be otherwise combined or separated via hardware and/or software.

The property service tracking system 300, as illustrated, may include the property service cloud database 340, an access control device 310, a first computer application 550 installed or accessible on a host computing device 500, a second computer application 650 installed or accessible on a service person computing device 600, and a third computing computer application 750 installed or accessible on a potential buyer computing device 700. It is understood that the first computer application 550, the second computer application 650, and the third computer application 750 may be the same mobile application but just installed on three different devices 500, 600, 700 and/or accessible from the three different devices 500, 600, 700. The first computer application 550, the second computer application 650, and the third computer application 750 may be accessible from three different devices 500, 600, 700 such as, for example, a software-as-as service or a website. The first computer application 550, the second computer application 650, and the third computer application 750 may be in communication with the cloud database via the internet 306.

The access control device 310 may be a smart lock system that controls access to a secured property 410. The access control device 310 may be an internet of things (IoT) connected device. The access control device 310 may be a smart lock, a smart door lock, a lock box that conceals a key or key card to access the secured property 410, a garage door control system, and any other similar access control device 310 that may secure access to a secured property 410. The secured property 410 may be a home, an apartment, a business, a building, a garage, a room, a shed, or any other secured area known to one of skill in the art. The secured property 410 may be owned by a host 402, rented by a host 402, in possession of a host 402, in control by the host 402, leased by the host 402, or mortgaged by the host 402. The host 402 may be a person, an organization, a group, a partnership, a company, or a corporation.

The access control device 310 includes a controller 330 that is configured to communicate with the first computer application 550, the second computer application 650, the third computer application 750, and the property service cloud database 340. The controller 330 may be an electronic controller including a processor 332 and an associated memory 334 comprising computer-executable instructions (i.e., computer program product) that, when executed by the processor 332, cause the processor 332 to perform various operations. The processor 332 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 334 may be but is not limited to a random access memory (RAM), read only memory (ROM), or other electronic, optical, magnetic or any other computer readable medium.

The controller 330 also includes a communication device 336. The communication device 336 may be capable of wireless communication including but not limited to Wi-Fi, Bluetooth, Zigbee, Sub-GHz RF Channel, cellular, satellite, or any other wireless signal known to one of skill in the art. The communication device 336 may be configured to communicate with the property service cloud database 340 through the internet 306 using the communication device 336. The communication device 336 may be connected to the internet 306 through a Wi-Fi router or home automation system (not shown). Alternatively, or additionally, the communication device 336 may be configured to communicate directly with the property service cloud database 340.

The property service cloud database 340 may belong to and/or be managed by a ledger maintainer 408, such as, for example a manufacturer of the access control, a third-party service provider, or any service provider that may maintain the public ledger 306. The public ledger 306 is a documented history of what service person 404 has visited the secured property 410, information about the service person 404 (e.g., name, company, title, or any other service person details), a receipt for the service performed, a receipt number, when the service person 404 visited the secured property 410, what service was performed by the service person 404 at the secured property 410 during their visit, and details about the service performed at the secured property 410, including notes or comments by the service person 404 on the service performed. The ledger maintainer 408 may be a person, an organization, a group, a partnership, a company, or a corporation.

In an alternate embodiment, the public ledger 386 may be distributed amongst multiple cloud databases rather than the single property service cloud database 340 that is illustrated in FIG. 1. In another embodiment, the public ledger 386 may be stored on a blockchain.

In another embodiment, all listings of secured properties 410 will be interconnected over the property service cloud database 340 with data of service persons 404 for better management of the listings.

The host computing device 500 may belong to or be in possession of a host 402 of the secured property 410. The service person computing device 600 may belong to or be in possession of a service person 404 to the secured property 410. The service person 404 may be coming to the secured property 410 to perform a service and will need access to the secured property 410 in order to perform that service, thus the service person 404 will need to actuate the access control device 310 in order to gain access to the secured property 410 to perform the service. The service person 404 may be a repair person repairing something at the secured property 410, a painter painting something at the secured property 410, a plumber fixing/installing plumbing at the secured property 410, an electrician fixing/installing electrical at the secured property 410, a pool repair persons fixing a pool at the secured property 410, a cleaning crew cleaning up water damage, a foundation crew fixing a crack in the foundation at the secured property 410, a cleaning service cleaning the secured property 410, a gardener maintaining landscaping at the secured property 410, an inspector inspecting something at the secured property 410 or the secured property 410 itself, or any service provider that may require access to the secured property to perform their service.

The property service cloud database 340 may be a remote computer server that includes a processor 342 and an associated memory 344 comprising computer-executable instructions (i.e., computer program product) that, when executed by the processor 342, cause the processor 342 to perform various operations. The processor 342 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 344 may be but is not limited to a random access memory (RAM), read only memory (ROM), or other electronic, optical, magnetic or any other computer readable medium.

The property service cloud database 340 also includes a communication device 346. The communication device 346 may be capable of communication with the internet. The communication device 346 may be configured to communicate with the host computing device 500 and the service person computing device 600 through the internet 306. The communication device 346 may be a software module that handles communications to and from the computer applications 550, 650.

The host computing device 500 may be a desktop computer, a laptop computer, or a mobile computing device that is typically carried by a person, such as, for example a phone, a smart phone, a PDA, a smart watch, a tablet, a laptop, or any other mobile computing device known to one of skill in the art.

The host computing device 500 includes a controller 510 configured to control operations of the host computing device 500. The controller 510 may be an electronic controller including a processor 530 and an associated memory 520 comprising computer-executable instructions (i.e., computer program product) that, when executed by the processor 530, cause the processor 530 to perform various operations. The processor 530 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 520 may be but is not limited to a random access memory (RAM), read only memory (ROM), or other electronic, optical, magnetic or any other computer readable medium.

The host computing device 500 includes a communication device 540 configured to communicate with the internet 306 through one or more wireless signals. The one or more wireless signals may include Wi-Fi, Bluetooth, Zigbee, Sub-GHz RF Channel, cellular, satellite, or any other wireless signal known to one of skill in the art. Alternatively, the host computing device 500 may be connected to the internet 306 through a hardwired connection. The host computing device 500 is configured to communicate with the property service cloud database 340 through the internet 306.

The host computing device 500 may include a display device 580, such as for example a computer display, an LCD display, an LED display, an OLED display, a touchscreen of a smart phone, tablet, or any other similar display device known to one of the skill in the art. A user operating the host computing device 500 is able to view the first computer application 550 through the display device 580.

The host computing device 500 includes an input device 570 configured to receive a manual input from a user (e.g., human being) of computing device 500. The input device 570 may be a keyboard, a touch screen, a joystick, a knob, a touchpad, one or more physical buttons, a microphone configured to receive a voice command, a camera or sensor configured to receive a gesture command, an inertial measurement unit configured to detect a shake of the host computing device 500, or any similar input device known to one of skill in the art. The user operating the host computing device 500 is able to enter data into the first computer application 550 through the input device 570. The input device 570 allows the user operating the host computing device 500 to data into the first computer application 550 via a manual input to input device 570. For example, the user may respond to a prompt on the display device 580 by entering a manual input via the input device 570. In one example, the manual input may be a touch on the touchscreen. In an embodiment, the display device 580 and the input device 570 may be combined into a single device, such as, for example, a touchscreen.

The host computing device 500 device may also include a feedback device 560. The feedback device 560 may activate in response to a manual input via the input device 570. The feedback device 560 may be a haptic feedback vibration device and/or a speaker emitting a sound. The feedback device 560 may activate to confirm that the manual input entered via the input device 570 was received via the first computer application 550. For example, the feedback device 560 may activate by emitting an audible sound or vibrate the host computing device 500 to confirm that the manual input entered via the input device 570 was received via the first computer application 550.

The host computing device 500 may also include a location determination device 590 that may be configured to determine a location of the host computing device 500 using cellular signal triangulation, a global position satellite (GPS), or any location termination method known to one of skill in the art.

The host 402 of the secured property 410 may be able to delegate access to the secured properties 410 via the access control 310 to a ledger maintainer 408.

The service person computing device 600 may be a desktop computer, a laptop computer, or a mobile computing device that is typically carried by a person, such as, for example a phone, a smart phone, a PDA, a smart watch, a tablet, a laptop, or any other mobile computing device known to one of skill in the art.

The service person computing device 600 includes a controller 610 configured to control operations of the service person computing device 600. The controller 610 may be an electronic controller including a processor 630 and an associated memory 620 comprising computer-executable instructions (i.e., computer program product) that, when executed by the processor 630, cause the processor 630 to perform various operations. The processor 630 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 620 may be but is not limited to a random access memory (RAM), read only memory (ROM), or other electronic, optical, magnetic or any other computer readable medium.

The service person computing device 600 includes a communication device 640 configured to communicate with the internet 306 through one or more wireless signals. The one or more wireless signals may include Wi-Fi, Bluetooth, Zigbee, Sub-GHz RF Channel, cellular, satellite, or any other wireless signal known to one of skill in the art. Alternatively, the service person computing device 600 may be connected to the internet 306 through a hardwired connection. The service person computing device 600 is configured to communicate with the property service cloud database 340 through the internet 306.

The service person computing device 600 may include a display device 680, such as for example a computer display, an LCD display, an LED display, an OLED display, a touchscreen of a smart phone, tablet, or any other similar display device known to one of the skill in the art. A user operating the service person computing device 600 is able to view the second computer application 650 through the display device 680.

The service person computing device 600 includes an input device 670 configured to receive a manual input from a user (e.g., human being) of computing device 600. The input device 670 may be a keyboard, a touch screen, a joystick, a knob, a touchpad, one or more physical buttons, a microphone configured to receive a voice command, a camera or sensor configured to receive a gesture command, an inertial measurement unit configured to detect a shake of the service person computing device 600, or any similar input device known to one of skill in the art. The user operating the service person computing device 600 is able to enter data into the second computer application 650 through the input device 670. The input device 670 allows the user operating the service person computing device 600 to data into the second computer application 650 via a manual input to input device 670. For example, the user may respond to a prompt on the display device 680 by entering a manual input via the input device 670. In one example, the manual input may be a touch on the touchscreen. In an embodiment, the display device 680 and the input device 670 may be combined into a single device, such as, for example, a touchscreen.

The service person computing device 600 device may also include a feedback device 660. The feedback device 660 may activate in response to a manual input via the input device 670. The feedback device 660 may be a haptic feedback vibration device and/or a speaker emitting a sound. The feedback device 660 may activate to confirm that the manual input entered via the input device 670 was received via the second computer application 650. For example, the feedback device 660 may activate by emitting an audible sound or vibrate the service person computing device 600 to confirm that the manual input entered via the input device 670 was received via the second computer application 650.

The service person computing device 600 may also include a location determination device 690 that may be configured to determine a location of the service person computing device 600 using cellular signal triangulation, a global position satellite (GPS), or any location termination method known to one of skill in the art.

The buyer computing device 700 may be a desktop computer, a laptop computer, or a mobile computing device that is typically carried by a person, such as, for example a phone, a smart phone, a PDA, a smart watch, a tablet, a laptop, or any other mobile computing device known to one of skill in the art.

The buyer computing device 700 includes a controller 710 configured to control operations of the buyer computing device 700. The controller 710 may be an electronic controller including a processor 730 and an associated memory 720 comprising computer-executable instructions (i.e., computer program product) that, when executed by the processor 730, cause the processor 730 to perform various operations. The processor 730 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 720 may be but is not limited to a random access memory (RAM), read only memory (ROM), or other electronic, optical, magnetic or any other computer readable medium.

The buyer computing device 700 includes a communication device 740 configured to communicate with the internet 306 through one or more wireless signals. The one or more wireless signals may include Wi-Fi, Bluetooth, Zigbee, Sub-GHz RF Channel, cellular, satellite, or any other wireless signal known to one of skill in the art. Alternatively, the buyer computing device 700 may be connected to the internet 306 through a hardwired connection. The buyer computing device 700 is configured to communicate with the property service cloud database 340 through the internet 306.

The buyer computing device 700 may include a display device 780, such as for example a computer display, an LCD display, an LED display, an OLED display, a touchscreen of a smart phone, tablet, or any other similar display device known to one of the skill in the art. A user operating the buyer computing device 700 is able to view the second computer application 750 through the display device 780.

The buyer computing device 700 includes an input device 770 configured to receive a manual input from a user (e.g., human being) of computing device 700. The input device 770 may be a keyboard, a touch screen, a joystick, a knob, a touchpad, one or more physical buttons, a microphone configured to receive a voice command, a camera or sensor configured to receive a gesture command, an inertial measurement unit configured to detect a shake of the buyer computing device 700, or any similar input device known to one of skill in the art. The user operating the buyer computing device 700 is able to enter data into the second computer application 750 through the input device 770. The input device 770 allows the user operating the buyer computing device 700 to data into the second computer application 750 via a manual input to input device 770. For example, the user may respond to a prompt on the display device 780 by entering a manual input via the input device 770. In one example, the manual input may be a touch on the touchscreen. In an embodiment, the display device 780 and the input device 770 may be combined into a single device, such as, for example, a touchscreen.

The buyer computing device 700 device may also include a feedback device 760. The feedback device 760 may activate in response to a manual input via the input device 770. The feedback device 760 may be a haptic feedback vibration device and/or a speaker emitting a sound. The feedback device 760 may activate to confirm that the manual input entered via the input device 770 was received via the second computer application 750. For example, the feedback device 760 may activate by emitting an audible sound or vibrate the buyer computing device 700 to confirm that the manual input entered via the input device 770 was received via the second computer application 750.

The buyer computing device 700 may also include a location determination device 790 that may be configured to determine a location of the buyer computing device 700 using cellular signal triangulation, a global position satellite (GPS), or any location termination method known to one of skill in the art.

When a service person 404 requires access to the secured property 410 they may use the second computer application 650 and the service person computing device 600 to transmit an actuation request 388 to the access control 310 in order to actuate the access control 310 and gain access to the secured property 410. The access request 388 may be transmitted directly from the service person computing device 600 to the access control 310. Alternatively, the actuation request 388 may be transmitted through the internet 306 to the access control 310. A credential 373 may be included in the access request 388 or it may be transmitted separately.

The service person 404 may require access to the secured property 410 to perform a service at the secured property 410. The actuation request 388 may include or be followed by a credential 373 (e.g., a set of data that encodes their access rights and is encrypted/signed cryptographically with the encryption key) associated with the access control 310.

The service person 404 may obtain the credential 373 to actuate the access control device 310 in a variety of different ways. The access control device 310 is programmed with an encryption key and a unique identifier (i.e., a serial number). The access control device 310 may be associated with the secured property 410 in the property service cloud database 340 or another cloud data base.

The credential 373 is sent to the service person computing device 600, which can then connect to the access control device 310 over the wireless communication from the communication device 640 of the service person computing device 600 to the communication device 336 of the access control device 310 and transfer the credential 373 with an actuation request 388. The access control device 310 validates the credential 373 and if the credential 373 is valid, the access control device 310 actuates (e.g., unlocks or opens).

In an alternate embodiment, the credential 373 from the service person computing device 600 may be used to authenticate the service person 404 as being an authorized person. The validation of the credential 373 (i.e., login/password) can be done by the property service cloud database 340 with prior knowledge of their ‘account’ information. Then, the second computer application 650 can download all of the access control devices 310 and secured properties 410 that the service person 404 is allowed to access. When the service person computing device 600 is in proximity, the service person 404 can select an option to ‘open’ the access control device 310 (e.g., lock) through the second computer application 650 to transmit an actuation request 388 to the database 340, which then verifies their credential 373 (i.e., they are authentic). Then, if their access rights in the database and everything is good, a message is sent over the internet 306 to the access control device 310 and the access control device 310 (e.g., lock) is actuated or opened.

In an alternate embodiment, the host computing device 500 could have a credential 373 for the access control device 310 that is sent to the property service cloud database 340 and then is shared with the service person 404 via the second computer application 650 of the service person computing device 600 so that the service person 404 can actuate the access control device 310.

The credential 373 may also be obtained by the potential buyer 406 of the secured property 410 using one of the aforementioned methods.

Following to or in parallel with the transmission of an actuation request 388, the service person 404 may be required to enter service details 384 into the second computer application 650. The service details 384 may be a description of what service is being or was performed at the secured property 410 that necessitated the service person 404 to access the secured property 410 through actuation of the access control 310. In one example, once the service person 404 arrives at the secured property 410 and access the access control 310 then the service person 404 may receive a message from the property service cloud database 340 via the service person computing device 600 asking the service person 404 to enter service details 384. In another embodiment, once the service person 404 leaves the secured property 410 then the service person 404 may receive a message from the property service cloud database 340 via the service person computing device 600 asking the service person 404 to enter service details 384.

Alternatively, the host 402 may be required to enter in service details 384 with each actuation request 388 by a service person 404 via the first computer application 550. Further, the host 402 may also upload service details 384 for work they have done on the secured property 410 themselves.

The service details 384 are time stamped with the time and the date of the service by the service person 404 and stored in the public ledger 386. The service details 384 may also include information regarding the service person 404 performing the service, including, but not limited to, name, company, years of experience, certifications, awards, or any other pertinent information that one may find useful to evaluate a service person 404.

The potential buyer computing device 700 may belong to or be in possession of a potential buyer 406 of the secured property 410, who may be visiting the secured property 410 for a showing. The potential buyer 410 may be an individual interested in buying the secured property 410 or a buyer's real-estate agent. Upon arriving at the secured property 410, the potential buyer 406 may utilize the third computer application 750 through the potential buyer computing device 700 to transmit an actuation request 388 to the access control 310 in order to actuate the access control 310 and gain access to the secured property 410 for the showing. The actuation request 388 may include a credential 373 to actuate the access control 310. The access request 388 may be transmitted directly from the potential buyer computing device 700 to the access control 310. Alternatively, the actuation request 388 may be transmitted through the internet 306 to the access control 310. The credential 373 may be included in the access request 388 or it may be transmitted separately.

If the credential 373 is valid then the access control 310 will actuate to allow the potential buyer 406 to gain access to the secured property 410 for the showing. Upon validation of the credential 373 and actuation of the access control 310, the property service cloud database 340 may be configured to transmit the public ledger 386 to the potential buyer computing device 700 and the potential buyer 406 may review the public ledger 386 through the third computer application 750. Alternatively, upon validation of the credential 373 the property service cloud database 340 may be configured to allow the potential buyer 406 to view the public ledger 386 through the internet 306 using the third computer application 750. The public ledger 386 may not be transmitted directly to the potential buyer computing device 700.

Alternatively, the potential buyer 406 of the secured property 410 may be able to retrieve the public ledger 386 without having to use a credential 373 and open the access device 310 at the secured property 410. For example, the potential buyer 406 may be an out of town buyer and may want to do a virtual tour, the public ledger 386 may be provided to the potential buyer 406 (e.g., buyer or their agent) through a public ledger request 389. The potential buyer 406 may then receive authorization to view the public ledger 386 via the potential buyer computing device 700 from the host 402 or a ledger maintainer 408.

Advantageously, by tracking all the services performed at the secured property 410 using the public ledger 386 and then allowing a potential buyer 406 of the secured property 410 to view that public ledger 386, the potential buyer 406 will have a better understanding of the history of the secured property 410 and all the services that have been performed there.

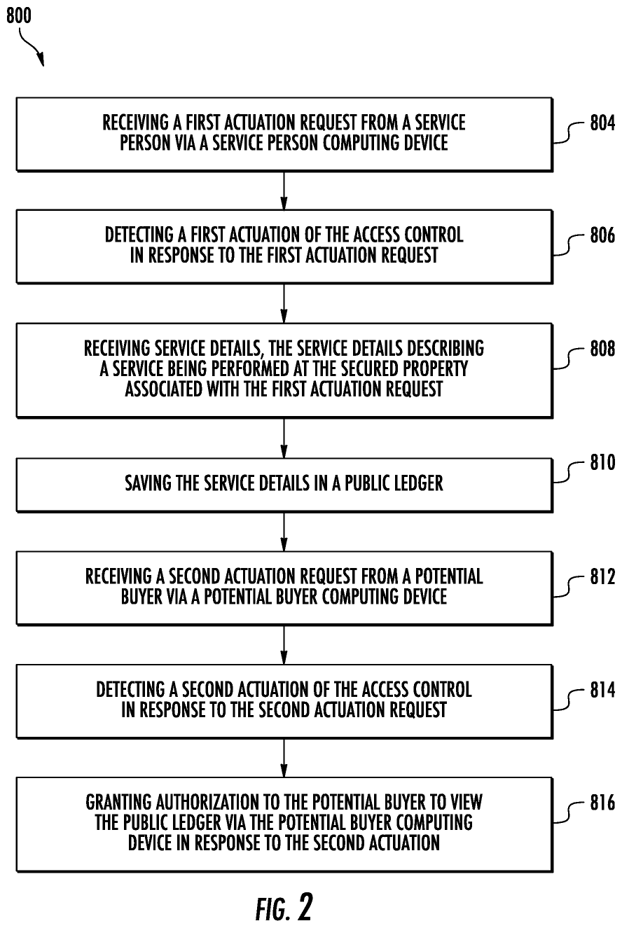

Referring to FIG. 2, within continued references to FIGS. 1-2, a flow diagram illustrating a method 800 documenting services performed for a secured property 410 is illustrated, in accordance with an embodiment of the present disclosure. In an embodiment, the method 800 may be performed by a property service tracking system 300.

At block 804, a first actuation request 388 from a service person 404 via a service person computing device 600 is received. The first actuation request 388 being directed to an access control 310 of the secured property 410.

At block 806, a first actuation of the access control 310 in response to the first actuation request 388 is detected.

At block 808, service details 384 are received. The service details 384 describing a service being performed at the secured property 410 associated with the first actuation request 388. The service details 384 may be received from the service person 404 via the service person computing device 600. Alternatively, the service details 384 may be received from a host 402 of the secured property 410 via a host computing device 500.

At block 810, the service details 384 are saved in a public ledger 386. The service details 384 may be saved in the public ledger 386 located on one or more property service cloud databases 340. The service details 384 may be saved in the public ledger 386 located on a blockchain. The service details 384 may be a description of what service is being performed at the secured property 410 that necessitated the service person 404 to access the secured property 410 through the first actuation of the access control 310.

At block 812, a second actuation request 388 from a potential buyer 406 via a potential buyer computing device 700 is received. The second actuation request 388 being directed to the access control 310 of the secured property 410.

At block 814, a second actuation of the access control 310 is detected in response to the second actuation request 388.

At block 816, authorization is granted to the potential buyer 406 to view the public ledger 386 via the potential buyer computing device 700 in response to the second actuation.

While the above description has described the flow process of FIG. 2 in a particular order, it should be appreciated that unless otherwise specifically required in the attached claims that the ordering of the steps may be varied.

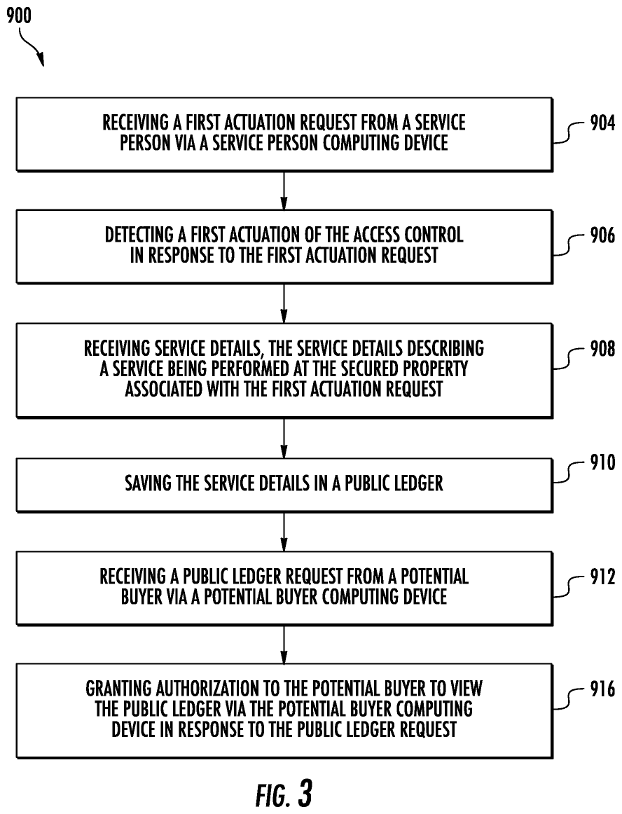

Referring to FIG. 3, within continued references to FIGS. 1-2, a flow diagram illustrating a method 900 documenting services performed for a secured property 410 is illustrated, in accordance with an embodiment of the present disclosure. In an embodiment, the method 900 may be performed by a property service tracking system 300.

At block 904, a first actuation request 388 from a service person 404 via a service person computing device 600 is received. The first actuation request 388 being directed to an access control 310 of the secured property 410.

At block 906, a first actuation of the access control 310 in response to the first actuation request 388 is detected.

At block 908, service details 384 are received. The service details 384 describing a service being performed at the secured property 410 associated with the first actuation request 388. The service details 384 may be received from the service person 404 via the service person computing device 600. Alternatively, the service details 384 may be received from a host 402 of the secured property 410 via a host computing device 500.

At block 910, the service details 384 are saved in a public ledger 386. The service details 384 may be saved in the public ledger 386 located on one or more property service cloud databases 340. The service details 384 may be saved in the public ledger 386 located on a blockchain. The service details 384 may be a description of what service is being performed at the secured property 410 that necessitated the service person 404 to access the secured property 410 through the first actuation of the access control 310.

At block 912, a public ledger request 389 from a potential buyer 406 via a potential buyer computing device 700 is received.

At block 916, authorization is granted to the potential buyer 406 to view the public ledger 386 via the potential buyer computing device 700 in response to the public ledger request 389.

While the above description has described the flow process of FIG. 3 in a particular order, it should be appreciated that unless otherwise specifically required in the attached claims that the ordering of the steps may be varied.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of documenting services performed for a secured property, the method comprising:
receiving a first actuation request from a service person via a service person computing device, the first actuation request being directed to an access control of the secured property;
detecting a first actuation of the access control in response to the first actuation request;
receiving service details, the service details describing a service being performed at the secured property associated with the first actuation request;
saving the service details in a public ledger;
receiving a second actuation request from a potential buyer via a potential buyer computing device, the second actuation request being directed to the access control of the secured property;
detecting a second actuation of the access control in response to the second actuation request; and
granting authorization to the potential buyer to view the public ledger via the potential buyer computing device in response to the second actuation.

2. The method of claim 1, wherein receiving the service details further comprises:
receiving the service details from the service person via the service person computing device.

3. The method of claim 1, wherein receiving the service details further comprises:
receiving the service details from a host of the secured property via a host computing device.

4. The method of claim 1, wherein saving the service details in the public ledger further comprises:
saving the service details in the public ledger located on one or more property service cloud databases.

5. The method of claim 1, wherein saving the service details in the public ledger further comprises:
saving the service details in the public ledger located on a blockchain.

6. The method of claim 1, wherein the service details are a description of what service is being performed at the secured property that necessitated the service person to access the secured property through the first actuation of the access control.

7. A property service tracking system for documenting services performed for a secured property, the property service tracking system comprising:
an access control configured to control access to the secured property;
a property service cloud database in communication with the access control, the property service cloud database comprising:
a processor; and
a memory comprising computer-executable instructions that, when executed by the processor, cause the processor to perform operations, the operations comprising:
receiving a first actuation request from a service person via a service person computing device, the first actuation request being directed to the access control of the secured property;
detecting a first actuation of the access control in response to the first actuation request;
receiving service details, the service details describing a service being performed at the secured property associated with the first actuation request;
saving the service details in a public ledger;
receiving a second actuation request from a potential buyer via a potential buyer computing device, the second actuation request being directed to the access control of the secured property;
detecting a second actuation of the access control in response to the second actuation request; and
granting authorization to the potential buyer to view the public ledger via the potential buyer computing device in response to the second actuation.

8. The property service tracking system of claim 7, wherein receiving the service details further comprises:
receiving the service details from the service person via the service person computing device.

9. The property service tracking system of claim 7, wherein receiving the service details further comprises:
receiving the service details from a host of the secured property via a host computing device.

10. The property service tracking system of claim 7, wherein saving the service details in the public ledger further comprises:
saving the service details in the public ledger located on one or more property service cloud databases.

11. The property service tracking system of claim 7, wherein saving the service details in the public ledger further comprises:
saving the service details in the public ledger located on a blockchain.

12. The property service tracking system of claim 7, wherein the service details are a description of what service is being performed at the secured property that necessitated the service person to access the secured property through the first actuation of the access control.

13. A method of documenting services performed for a secured property, the method comprising:
receiving a first actuation request from a service person via a service person computing device, the first actuation request being directed to an access control of the secured property;
detecting a first actuation of the access control in response to the first actuation request;
receiving service details, the service details describing a service being performed at the secured property associated with the first actuation request;
saving the service details in a public ledger;
receiving a public ledger request from a potential buyer via a potential buyer computing device; and
granting authorization to the potential buyer to view the public ledger via the potential buyer computing device in response to the public ledger request.

14. The method of claim 13, wherein receiving the service details further comprises:
receiving the service details from the service person via the service person computing device.

15. The method of claim 13, wherein receiving the service details further comprises:
receiving the service details from a host of the secured property via a host computing device.

16. The method of claim 13, wherein saving the service details in the public ledger further comprises:
saving the service details in the public ledger located on one or more property service cloud databases.

17. The method of claim 13, wherein saving the service details in the public ledger further comprises:
saving the service details in the public ledger located on a blockchain.

18. The method of claim 13, wherein the service details are a description of what service is being performed at the secured property that necessitated the service person to access the secured property through the first actuation of the access control.
